(19) United States
(12) Patent Application Publication
(10) Pub. No.: US 2025/0143493 A1
(43) Pub. Date: May 8, 2025

(54) Utensil with Storage

(71) Applicant: Taylor Michelle Pitt, Boone, NC (US)

(72) Inventor: Taylor Michelle Pitt, Boone, NC (US)

(21) Appl. No.: 18/933,629

(22) Filed: Oct. 31, 2024

Related U.S. Application Data
(60) Provisional application No. 63/547,185, filed on Nov. 3, 2023.

(51) Int. Cl. A47G 21/02; A47G 21/04; B26B 3/02

(52) U.S. Cl. CPC A47G 21/02; A47G 21/023; A47G 21/04; B26B 3/02

(57) ABSTRACT

A utensil with storage that allows a user to store seasonings for food or other materials in the hollow body of the handle of the utensil. The hollow body having an anterior and posterior end. A utensil head is attached to a central shaft extending through the hollow body. When the central shaft is turned, the contents contained in the hollow body are dispensed from the anterior end of the hollow body. The amount of content dispensed may be predetermined and based on a select number of rotations of the central shaft.

### CROSS-REFERENCE TO RELATED APPLICATION

This application claims benefit of, and priority to, U.S. Provisional Patent Application Ser. No. 63/547,185, filed Nov. 3, 2023, the entire contents of which are hereby incorporated by reference.

### BACKGROUND

### 1. Technical Field

The present disclosure relates to a utensil, more specifically to a utensil that can hold and dispense contents all while being lightweight and compact.

### 2. Discussion of Related Art

Hikers and campers often prepare their own food when on an outing. To make that food taste better the hiker or camper will season the food with a variety of seasonings, such as salt, pepper, and other herbs and spices. The hiker or camper will have to bring separate containers for reach seasoning. This can result in multiple containers that may or may not be transparent and thus require marking or some other indicia to indicate its contents.

Hikers and campers need a way of carrying seasonings in a manner that reduces the number of containers one must carry, be readily ascertainable (i.e., one can see and determine the seasoning), and be in a durable container.

### SUMMARY

This disclosure relates generally to a utensil having storage within the handle of the utensil. The storage space may be used for any content but is designed to hold seasonings for food, such as salt, pepper, herbs, and spices.

The utensil detailed herein is comprised of a hollow body having anterior and posterior end and a storage area for storing contents between the anterior and posterior ends, a utensil tip member affixed to the anterior end of a central shaft member, the central shaft member, extending longitudinally through the hollow body, and forming a seal at the anterior end of the storage area, the central shaft having extensions that, when turned, force any contents within the storage area to dispense through the posterior end of the hollow body, the central shaft rotatable by turning the utensil tip member, and a cap removably affixed to the posterior end of the shaft member. The utensil may also have an O-ring between the central shaft member and the hollow body in order to seal and secure the utensil tip member to the hollow body.

The utensil may have a utensil tip member being a fork or spoon head. Alternatively, the utensil tip member may be a knife blade.

In one embodiment, the central shaft has extensions that are formed in the configuration of an Archimedes screw. Thus, when the central shaft is turned in the correct direction depending on the configuration of the extensions, any material stored in the hollow body is dispensed out the anterior end of the hollow body.

The utensil components may be made of various materials. The preferred materials will result in a lightweight but durable utensil. In particular, the cap may be rubber. The hollow body may be made of food grade polypropylene. The utensil member may be made of magnesium. The O-ring may be made of nitrile. The central shaft member may be made of metal, preferably magnesium.

The cap may be affixed to the anterior end of the hollow body by way of pressure fit or, alternatively, by a threaded connection.

The utensil may also be configured to dispense a predetermined unit of measurement of the contents of the hollow body depending on the number of times the central shaft is rotated. For example, one predetermined unit of measurement is a teaspoon. In other example, a predetermined unit of measurement is a tablespoon.

In some embodiments, a kit may be comprised of multiple utensils disclosed herein so that the kit makes a set of utensils comprising a knife, fork, and spoon.

Further, to the extent consistent, any of the embodiments or aspects described herein may be used in conjunction with any or all of the other embodiments or aspects described herein.

### BRIEF DESCRIPTION OF THE DRAWINGS

Various aspects of the present disclosure are described hereinbelow with reference to the drawings, which are incorporated in and constitute a part of this specification, wherein:

FIG. 1 is a top schematic view of a utensil with storage;

FIG. 2 is a side schematic view of the utensil with storage of FIG. 1;

FIG. 3 is a perspective view of the utensil with storage of FIG. 1; and

FIG. 4 is an exploded view of the utensil showing various components of one embodiment.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

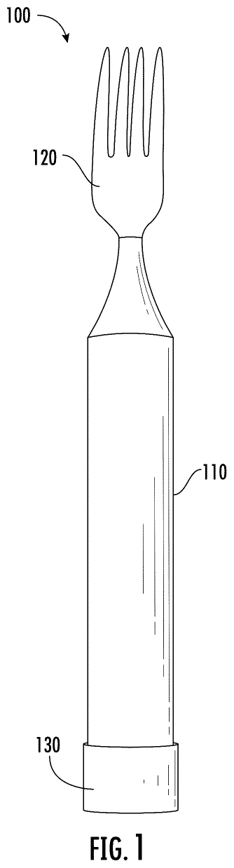

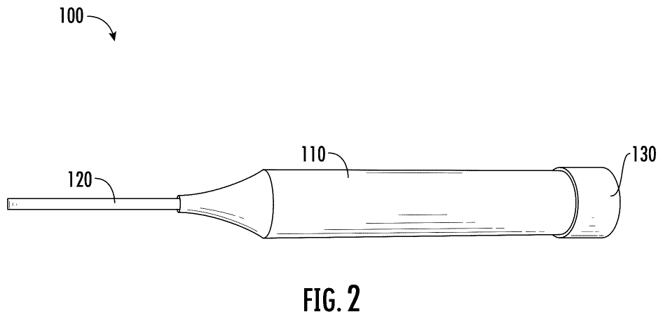

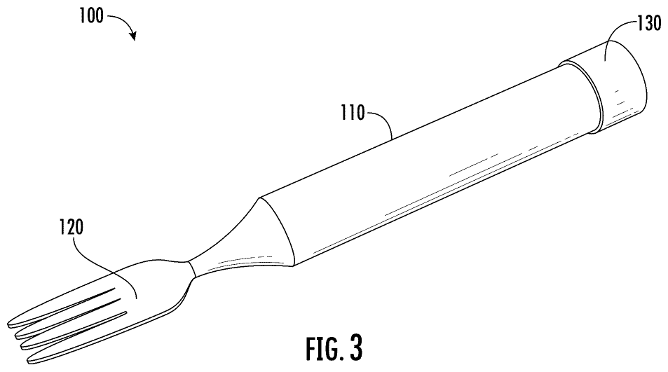

Referring now to FIGS. 1, 2, and 3, a utensil having storage is illustrated and generally referred to as utensil 100. The utensil includes a hollow body 110, a utensil tip member 120, and a cap 130.

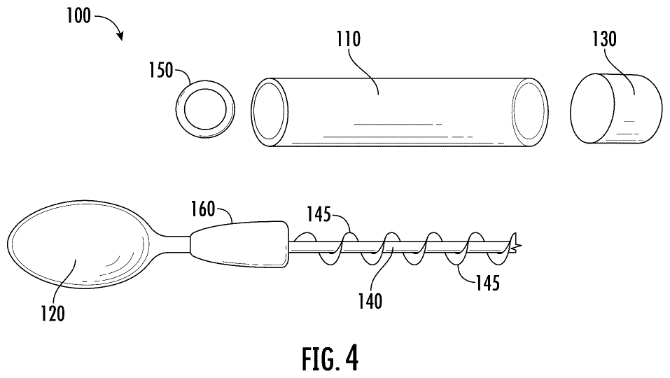

Referring now to FIG. 4, a utensil having storage is illustrated and generally referred to as utensil 100. The utensil includes a hollow body 110, a utensil tip member 120, a cap 130, a central shaft 140, and an O-ring 150. The central shaft 130 has extensions 145 that are formed in the shape of an Archimedes screw.

The hollow body 110 may be cylindrical and take the shape of a hollow tube. The hollow body 110 may be made of food grade polypropylene. The polypropylene may be clear or opaque and thus allow a user to see the contents therein. A user can then quickly and easily tell what is inside the hollow body 110 and how much of the contents remain. The hollow body 110, however, need not be cylindrical and could, for example, be hexagonal in cross-section. The hollow body 110 may also be manufactured with a rough outer surface to allow the user to obtain a grip on the utensil, even in wet or cold conditions.

The central shaft 145 may be cylindrical and extend longitudinally through the hollow body 110. The central shaft 145 may include a tapered neck 160 that mates with the anterior opening of the hollow body 110. The O-ring 150 may be placed between the anterior end of the hollow body 110 and the tapered neck 160 of the central shaft 145. The tapered neck may be made of rubber or another food safe material.

In one embodiment, the cap 130 attaches to the hollow body 110 through pressure fit. In other embodiment, the cap 130 attaches to the hollow body by way of threaded attachment and thus screws onto the posterior end of the hollow body 110.

The utensil 100 is configured so that the rotation of the central shaft 140 dispenses contents of the hollow body 110 from the anterior end of the hollow body 110. The extensions 145 of the central shaft may be configured so that rotation of the central shaft 145 causes the contents to move towards the anterior end of the hollow body 110.

The utensil 100 may be configured so that the extensions 145 on the central shaft 140 are configured so that a predetermined number of rotations of the utensil tip 120 dispenses a predetermined amount of the contents from the hollow body 110. The predetermined amounts may be a teaspoon in one embodiment and a tablespoon in another embodiment. In one embodiment, a 360° rotation of the utensil tip 120 causes approximately a teaspoon of contents to be dispensed from the anterior end of the hollow body 110. In another embodiment, three (3) 360° rotations of the utensil tip 120 causes approximately a tablespoon of contents to be dispensed from the anterior end of the hollow body 110.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed:

1. A utensil comprising:
a. a hollow body having anterior and posterior end and a storage area for storing contents between the anterior and posterior ends,
b. a utensil tip member affixed to the anterior end of a central shaft member,
c. the central shaft member, extending longitudinally through the hollow body, and forming a seal at the anterior end of the storage area,
d. the central shaft having extensions that, when turned, force any contents within the storage area to dispense through the posterior end of the hollow body, the central shaft rotatable by turning the utensil tip member,
e. a cap removably affixed to the posterior end of the shaft member.

2. The utensil of claim 1, further comprising an O-ring between the central shaft member and the hollow body.

3. The utensil of claim 1, wherein the utensil tip member being a fork head.

4. The utensil of claim 1, wherein the utensil tip member being a spoon head.

5. The utensil of claim 1, wherein the utensil tip member is a knife blade.

6. The utensil of claim 1, wherein the extensions on the central shaft member are formed in the configuration of an Archimedes screw.

7. The utensil of claim 1, wherein the cap is comprised of rubber.

8. The utensil of claim 1, wherein the hollow body is comprised of food grade polypropylene.

9. The utensil of claim 1, wherein the utensil member is comprised of magnesium.

10. The utensil of claim 1, wherein the O-ring is comprised of nitrile.

11. The utensil of claim 1, wherein the central shaft member is comprised of metal.

12. The utensil of claim 1, wherein the cap is affixed to the hollow body by pressure fit.

13. The utensil of claim 1, wherein the cap is affixed to the hollow body by threaded attachment.

14. The utensil of claim 1, wherein the number of rotations of the utensil tip member is equivalent to a predetermined unit of measurement.

15. The utensil of claim 14, wherein a predetermined number of rotations of the utensil tip member is equivalent to a teaspoon.

16. The utensil of claim 14, wherein a predetermined number of rotations of the utensil tip member is equivalent to a tablespoon.

17. The utensil of claim 1, wherein the central shaft extends through a taper neck located between the utensil tip and the hollow body.

18. The utensil of claim 1, wherein the hollow body is a cylindrical tube.

19. The utensil of claim 1, wherein the hollow body is hexagonal in cross-section.

20. The utensil of claim 1, wherein the hollow body has a textured outer surface.
